(19) United States
(12) Patent Application Publication
(10) Pub. No.: US 2024/0171694 A1
(43) Pub. Date: May 23, 2024

(54) IMAGE READING APPARATUS

(71) Applicant: FUJIFILM Business Innovation Corp., Tokyo (JP)

(72) Inventor: Tadashi SUGIZAKI, Kanagawa (JP)

(73) Assignee: FUJIFILM Business Innovation Corp., Tokyo (JP)

(21) Appl. No.: 18/324,997

(22) Filed: May 28, 2023

(30) Foreign Application Priority Data
Nov. 22, 2022 (JP) 2022-186854

(51) Int. Cl. H04N 1/028; H04N 1/12

(52) U.S. Cl. CPC H04N 1/0285; H04N 1/1225

(57) ABSTRACT

An image reading apparatus includes: a transport unit that transports a sheet including an image; and a reading unit that includes a mirror plate of which both end portions in a longitudinal direction are held, reflects reflected light, which is obtained by illuminating the sheet transported by the transport unit with light, by a reflecting surface of the mirror plate, and reads the image, in which a vibration-resistant member, which imparts vibration resistance, is disposed on a part of some surfaces of the mirror plate other than the reflecting surface not to protrude from the reflecting surface.

### CROSS-REFERENCE TO RELATED APPLICATIONS

This application is based on and claims priority under 35 USC 119 from Japanese Patent Application No. 2022-186854 filed Nov. 22, 2022.

### BACKGROUND

### (i) Technical Field

The present invention relates to an image reading apparatus.

### (ii) RELATED ART

JP1989-142913U (Claims, FIG. 1) discloses an anti-vibration structure for a laser beam optical system mirror in which a rigid plate adheres to a back of a mirror via an adhesive member having elasticity in a laser beam optical system which reflects a laser beam by the mirror and irradiates a photoreceptor with the laser beam.

JP5064818B (claim 5, FIGS. 1, 8, 9, and 14) discloses an image reading apparatus that forms an image of a document on a photoelectric conversion element via a mirror and a lens and reads image information of the document.

Further, JP5064818B (claim 5, FIGS. 1, 8, 9, and 14) also discloses a mirror that is used as a mirror of the image reading apparatus. A reflecting surface of the mirror has an elongated shape, a reinforcing member is fixed to a side surface of the mirror with respect to the reflecting surface of the mirror, the reinforcing member has a width that allows the reinforcing member to protrude from the mirror to both sides or one side in a direction perpendicular to the reflecting surface, and a length of the reinforcing member in a longitudinal direction and the width of the reinforcing member satisfy a specific conditional expression.

JP2013-41171A (claim 1, FIGS. 2, 4, and 10) discloses an optical scanning device including: a light source; an optical unit that includes a lens and a mirror and guides a light beam generated from the light source to a photoreceptor; and a dynamic vibration absorber that is mounted on the lens or the mirror and resonates with a natural frequency of the lens or the mirror to suppress vibration of the lens or the mirror.

Further, JP2013-41171A (claim 1, FIGS. 2, 4, and 10) also discloses that, in the optical scanning device, the dynamic vibration absorber includes a plate member, a plurality of viscoelastic bodies, and a weight, the plate member is mounted on the lens or the mirror via the plurality of viscoelastic bodies, and the weight is mounted between the plurality of viscoelastic bodies.

### SUMMARY

Aspects of non-limiting embodiments of the present disclosure relate to an image reading apparatus that reflects reflected light, which is obtained by illuminating a transported sheet with light, by a reflecting surface of a mirror plate to read an image formed on the sheet and reduces the shaking of the mirror plate without causing a deterioration in the flatness of the reflecting surface and the generation of stray light as compared to a case where a vibration-resistant member, which imparts vibration resistance, is not disposed on a part of some surfaces of the mirror plate other than the reflecting surface, even though the image reading apparatus receives vibration caused by an operation, such as an operation for transporting the sheet.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image reading apparatus including: a transport unit that transports a sheet including an image; and a reading unit that includes a mirror plate of which both end portions in a longitudinal direction are held, reflects reflected light, which is obtained by illuminating the sheet transported by the transport unit with light, by a reflecting surface of the mirror plate, and reads the image, in which a vibration-resistant member, which imparts vibration resistance, is disposed on a part of some surfaces of the mirror plate other than the reflecting surface not to protrude from the reflecting surface.

### BRIEF DESCRIPTION OF THE DRAWINGS

Exemplary embodiment(s) of the present invention will be described in detail based on the following figures, wherein:

FIG. 1 is a schematic diagram showing an image reading apparatus according to a first exemplary embodiment;

FIG. 2 is an enlarged schematic diagram showing a reading unit and the like of the image reading apparatus shown in FIG. 1;

FIG. 3A is a schematic diagram showing a state where a mirror plate is held, FIG. 3B is a schematic diagram showing a structure that holds the mirror plate, and FIG. 3C is a schematic diagram showing mounting plates on which the mirror plate is mounted;

FIG. 4A is a perspective view of the mirror plate on which side reinforcing plates as a vibration-resistant member of the first exemplary embodiment are disposed, FIG. 4B is a longitudinal side view of the mirror plate shown in FIG. 4A, and FIG. 4C is a cross-sectional view of the mirror plate shown in FIG. 4A taken along line C-C;

FIG. 5 is a diagram illustrating a holding state and shaking of the mirror plate shown in FIGS. 4A, 4B, and 4C;

FIG. 6A is a perspective view of the mirror plate on which side reinforcing plates of Modification Example 1 are disposed, and FIG. 6B is a cross-sectional view of the mirror plate shown in FIG. 6A taken along line B-B;

FIG. 7A is a perspective view of the mirror plate on which side reinforcing plates of Modification Example 2 are disposed, and FIG. 7B is a cross-sectional view of the mirror plate shown in FIG. 7A taken along line B-B;

FIG. 8A is a perspective view of the mirror plate on which side reinforcing plates of Modification Example 3 are disposed, and FIG. 8B is a cross-sectional view of the mirror plate shown in FIG. 8A taken along line B-B;

FIG. 9A is a perspective view of the mirror plate on which side reinforcing plates of Modification Example 4 are disposed, and FIG. 9B is a cross-sectional view of the mirror plate shown in FIG. 9A taken along line B-B;

FIG. 10A is a perspective view of the mirror plate on which a side reinforcing plate of Modification Example 5 is disposed, and FIG. 10B is a cross-sectional view of the mirror plate shown in FIG. 10A taken along line B-B;

FIG. 11A is a perspective view of the mirror plate on which back reinforcing plates are arranged as a vibration-resistant member in a reading unit of an image reading apparatus according to a second exemplary embodiment, FIG. 11B is a cross-sectional view of the mirror plate shown in FIG. 11A taken along line B-B, and FIG. 11C is a lateral side view of the mirror plate shown in FIG. 11A;

FIG. 12A is a side view of the mirror plate on which first pressing members are provided on a plurality of back reinforcing plates, and FIG. 12B is another side view of the mirror plate shown in FIG. 12A;

FIG. 13A is a side view of the mirror plate on which a plate and second pressing members are provided on a plurality of back reinforcing plates, and FIG. 13B is another side view of the mirror plate shown in FIG. 13A; and

FIG. 14A is a perspective view of the mirror plate on which back pressing members are arranged as a vibration-resistant member in a reading unit of an image reading apparatus according to a third exemplary embodiment, FIG. 14B is a longitudinal side view of the mirror plate shown in FIG. 14A, and FIG. 14C is a cross-sectional view of the mirror plate shown in FIG. 14A taken along line C-C.

### DETAILED DESCRIPTION

Exemplary embodiments of the present invention will be described below.

### First Exemplary Embodiment

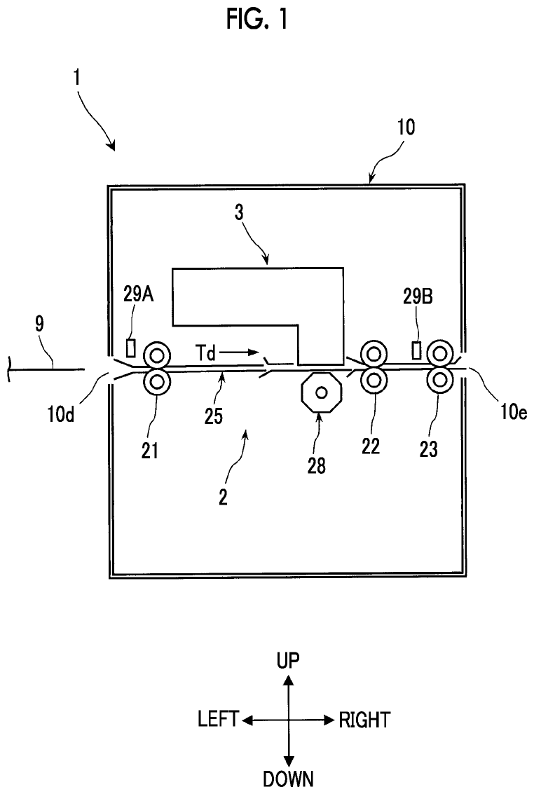

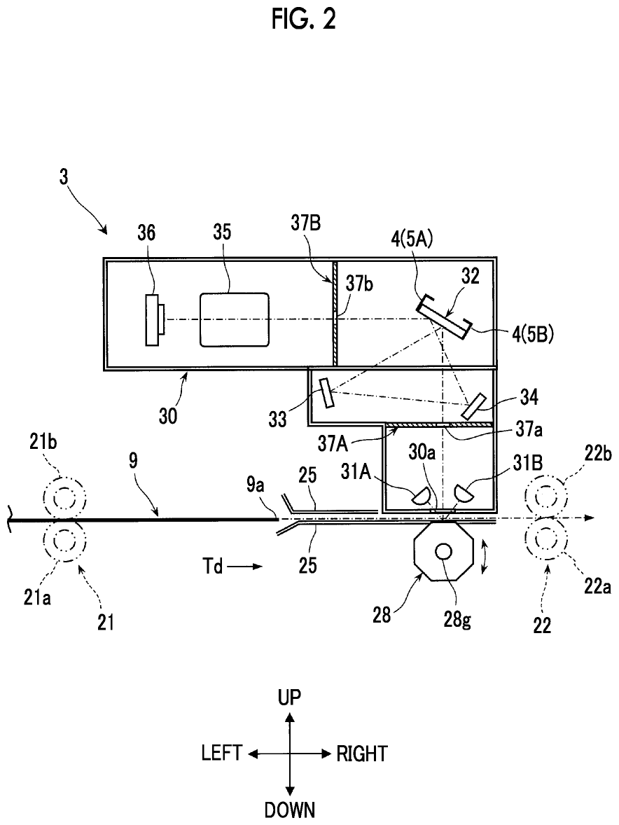

FIG. 1 shows an outline of an image reading apparatus 1 according to a first exemplary embodiment of the present invention. FIG. 2 shows a state where a reading unit and the like, which are a part of the image reading apparatus 1, are enlarged.

Substantially identical components will be denoted in this specification and the drawings by identical reference numerals, and the repeated description of the components will be omitted in this specification.

The image reading apparatus 1 is an apparatus that reads an image on a transported sheet 9. The image on the sheet 9 is, for example, an image formed by an image forming apparatus that forms an image on the sheet 9. Further, an image is information, such as texts, symbols, lines, figures, patterns, colors, and photographs fixed to the sheet 9. The sheet 9 may be any recording medium that can be transported and subjected to a reading operation by the image reading apparatus 1, and the type and the like of the sheet 9 are not particularly limited.

Further, in a case where the image reading apparatus 1 is used to inspect an image formed on the sheet 9, the image reading apparatus 1 can also be referred to as, for example, an image inspection apparatus. In this case, the image reading apparatus 1 is used while being connected to the image forming apparatus, or is used while being disposed as one functional part in the image forming apparatus.

As shown in FIG. 1, the image reading apparatus 1 includes a transport unit 2 that transports a sheet 9 including an image, and a reading unit 3 that reads at least the image of the sheet 9 transported by the transport unit 2. More specifically, the image reading apparatus 1 further also includes: a power supply unit (not shown); a controller (not shown) that controls the operations of the transport unit 2, the reading unit 3, the power supply unit, and the like; and the like.

Reference numeral 10 shown in FIG. 1 denotes a housing that includes a frame member, an exterior material, and the like. Components, such as the transport unit 2 and the reading unit 3, are housed in the housing 10. Further, the housing 10 is provided with a carry-in port 10d through which the sheet 9 including the image to be read is carried in, and a discharge port 10e from which the read sheet 9 is discharged.

The transport unit 2 is a part that is provided in the housing 10 and is configured to transport the sheet 9 including the image to be read such that the sheet 9 passes through a reading position of the reading unit 3.

As shown in FIGS. 1 and 2, the transport unit 2 includes a pair of transport rollers 21, a pair of transport rollers 22, a pair of transport rollers 23, transport guide members 25, and the like.

The pair of transport rollers 21 is a combination of a drive roller 21a that obtains power from a drive device, such as a motor, (not shown) to be rotationally driven in a required direction and a driven roller 21b that is in contact with the drive roller 21a and is driven to rotate. The pair of transport rollers 21 is disposed as introduction rollers at a position slightly away from the carry-in port 10d of the housing 10 to the downstream side in a transport direction Td of the sheet 9.

The pair of transport rollers 22 is a combination of a drive roller 22a and a driven roller 22b, and is disposed as transport rollers after reading at a position near the downstream side in the transport direction Td from the reading position of the reading unit 3. The pair of transport rollers 23 is a combination of a drive roller and a driven roller, and is disposed as discharge rollers at a position near the upstream side in the transport direction Td from the discharge port 10e of the housing 10.

The transport guide members 25 are members that guide the carried sheet 9 to be discharged after causing the sheet 9 to pass through the reading position of the reading unit 3. The transport guide members 25 are disposed in a state where the transport guide members 25 face each other with an interval therebetween in a vertical direction to ensure a transport space for the sheet 9 to be transported.

Further, as shown in FIG. 1, a calibration unit 28 and sheet end portion-detection sensors 29A and 29B are disposed in the reading unit 3 of the first exemplary embodiment.

The calibration unit 28 is formed of a polygonal columnar polyhedron on which functional surfaces, such as a sheet transport surface, an optical correction surface of the reading unit 3, and a cleaning action surface for a transparent window 30a, which will be described later, of the reading unit 3, are arranged.

The calibration unit 28 is disposed at a position where each of the plurality of functional surfaces faces the reading position (actually, the transparent window 30a) of the reading unit 3 with a required interval between the functional surface and the reading position. Further, the calibration unit 28 is configured to rotate about a rotating shaft 28g and to stop such that each of the plurality of functional surfaces faces the transparent window 30a of the reading unit 3 in parallel to the transparent window 30a at a required time, or is configured to rotate such that each of the plurality of functional surfaces passes by the transparent window 30a while being close to the transparent window 30a.

The sheet end portion-detection sensor 29A is a detection unit that detects the passage of a front end 9a of the sheet 9 to be carried in, and is disposed between the carry-in port 10d of the housing 10 and the pair of transport rollers 21. The sheet end portion-detection sensor 29B is a detection unit that detects the passage of a rear end of the sheet 9 to be discharged, and is disposed between the pair of transport rollers 22 and the pair of transport rollers 23.

As shown in FIG. 2, the reading unit 3 includes devices, such as a housing 30, an illumination device 31, a plurality of mirror plates (32, 33, and 34), an imaging lens 35, and an imaging device 36.

The housing 30 is a structure in which the components of the reading unit to be described later are stored and disposed.

The housing 30 of the first exemplary embodiment is formed as a structure having an external shape of a letter L that is laid down sideways as viewed from the front. The housing 30 is formed to prevent unnecessary light from entering from the outside. Further, the transparent window 30a, which transmits light, is disposed at a portion (the lowest surface portion) of the housing 30 corresponding to the reading position.

The illumination device 31 is a device that irradiates the surface of the sheet 9, which is transported by the transport unit 2, with light at required angles from the upstream side and the downstream side in the transport direction Td of the sheet 9.

The illumination device 31 is configured using, for example, a light source, such as a light-emitting diode (LED). Further, the illumination device 31 causes light to pass through the transparent window 30a, which is disposed in the housing 30 at a position facing a transport passage of the sheet 9, and emits light.

In the reading unit 3, a first light shielding plate 37A provided with a horizontally long first slit hole 37a, which specifies a part of reflected light entering from the transparent window 30a and causes the part of reflected light to pass, is disposed between the transparent window 30a and the plurality of mirror plates.

The plurality of mirror plates (32, 33, and 34) are reflective plates that regularly reflect reflected light, which is obtained from the sheet 9 in a case where the sheet 9 is illuminated with light by the illumination device 31, and guides the reflected light in a required direction.

Further, each of the plurality of mirror plates (32, 33, and 34) is a mirror plate in which, for example, a material such as aluminum is vapor-deposited on one surface of a substrate, which is formed as a rectangular flat plate extending in one direction with a material such as glass, to form a mirror surface layer.

In the first exemplary embodiment, three mirror plates, that is, a first mirror plate 32, a second mirror plate 33, and a third mirror plate 34 are used as the plurality of mirror plates (32, 33, and 34).

Further, the first mirror plate 32 is formed as a mirror plate that reflects light twice. Each of the second mirror plate 33 and the third mirror plate 34 is formed as a mirror plate that reflects light once.

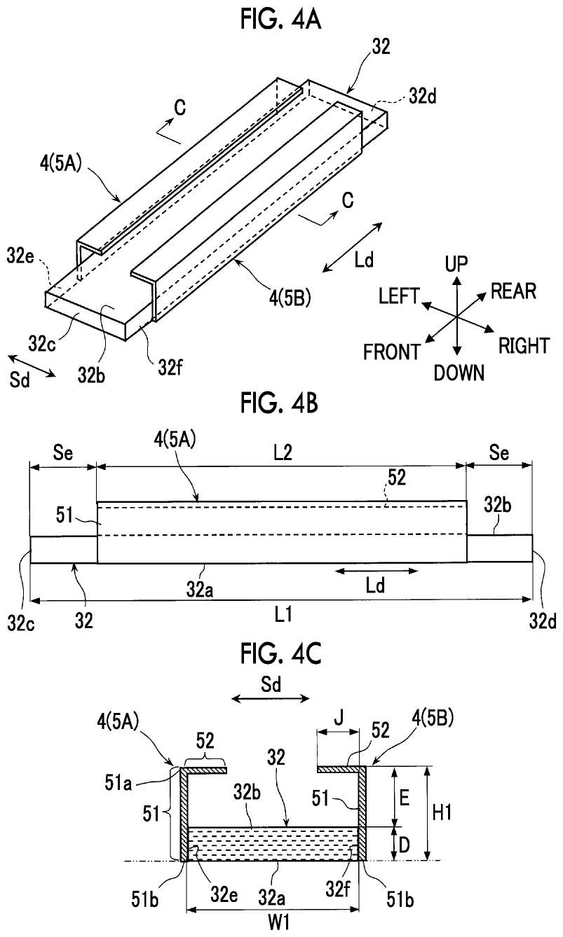

For this reason, the first mirror plate 32 is formed such that a width (dimension in a lateral direction Sd) W1 (see FIGS. 4A, 4B, and 4C) of the first mirror plate 32 is about two times as large as the width of each of the second mirror plate 33 and the third mirror plate 34.

Further, as shown in FIG. 2, the first mirror plate 32 is disposed at a required position in the housing 30 such that a reflecting surface of the first mirror plate 32 is oriented in a required direction to receive reflected light (one-dot chain line in FIG. 2) from the sheet 9 first and then reflect the reflected light toward the second mirror plate 33 and to receive reflected light (one-dot chain line in FIG. 2) from the third mirror plate 34 and then reflect the reflected light toward the imaging lens 35 and the like.

The second mirror plate 33 is disposed at a required position in the housing 30 such that a reflecting surface of the second mirror plate 33 is oriented in a required direction to receive reflected light (one-dot chain line in FIG. 2) from the first mirror plate 32 and then reflect the reflected light toward the third mirror plate 34.

The third mirror plate 34 is disposed at a required position in the housing 30 such that a reflecting surface of the third mirror plate 34 is oriented in a required direction to receive reflected light (one-dot chain line in FIG. 2) from the second mirror plate 33 and then reflect the reflected light toward the first mirror plate 32.

In addition, the first mirror plate 32, the second mirror plate 33, and the third mirror plate 34 are mounted in the housing 30 in a state where both end portions of each of the first mirror plate 32, the second mirror plate 33, and the third mirror plate 34 in a longitudinal direction Ld are held.

A structure for holding this mirror plate will be described later.

The imaging lens 35 is a lens that optically reduces light from the first mirror plate 32 and forms an image. The imaging lens 35 is disposed at a position that corresponds to an optical path between the first mirror plate 32 and the imaging device 36 in the housing 30.

In the first exemplary embodiment, a second light shielding plate 37B provided with a horizontally long second slit hole 37b, which specifies a part of reflected light from the first mirror plate 32 and causes the part of reflected light to pass, is disposed between the first mirror plate 32 and the imaging lens 35.

The imaging device 36 is a device that converts light (optical image) captured by the imaging lens 35 into electrical signals to form an image. The imaging device 36 is configured using a device, such as an image sensor.

Here, a structure for holding the mirror plate will be described using the first mirror plate 32 as an example.

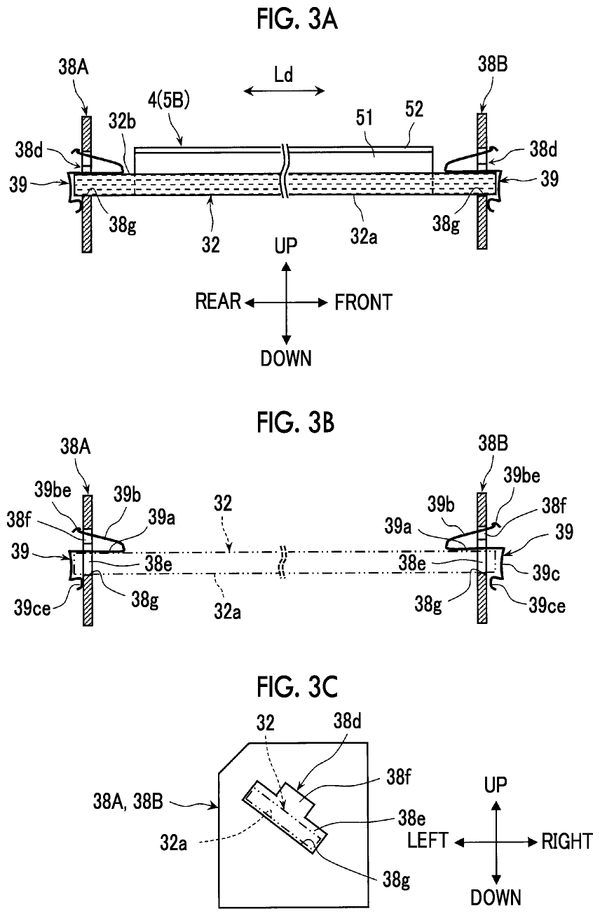

As shown in FIG. 3A, the first mirror plate 32 is adapted such that both end portions of the first mirror plate 32 in the longitudinal direction Ld are held on a pair of mounting plates 38A and 38B provided in the housing 30 via holders 39.

The pair of mounting plates 38A and 38B are provided at a position in the housing 30 where the first mirror plate 32 is to be disposed in a state where the mounting plates 38A and 38B face each other with an interval between the mounting plates 38A and 38B to hold both the end portions of the first mirror plate 32 in a required posture.

Further, as shown in FIGS. 3B and 3C, the pair of mounting plates 38A and 38B is provided with holding holes 38d that hold both the end portions of the first mirror plate 32 in a predetermined posture (inclination angle), respectively.

As shown in FIG. 3C, each of the holding holes 38d is a through-hole that includes a holding portion 38e and a locking portion 38f. The holding portion 38e is a rectangular hole major portion having a size that allows each of both the end portions of the first mirror plate 32 and a part (a pressing portion 39a to be described later) of the holder 39 to pass obliquely upward with a margin.

The locking portion 38f is a rectangular dent portion that protrudes from a part of the holding portion 38e including the middle of an upper side of the holding portion 38e and has a size allowing a part (an elastic pushing portion 39b to be described later) of the holder 39 to pass.

A lower side of the holding portion 38e is formed as a positioning side 38g against which at least the reflecting surface 32a at each of both the end portions of the first mirror plate 32 is positioned by being pressed.

The holders 39 are leaf spring-shaped jigs that press portions of a back 32b opposite to the reflecting surface 32a at both the end portions of the first mirror plate 32 against the positioning sides 38g of the holding holes 38d of the mounting plates 38A and 38B.

As shown in FIG. 3B, the holder 39 of the first exemplary embodiment is formed in a shape that includes a pressing portion 39a, an elastic pushing portion 39b, and an end portion-restricting portion 39c.

The pressing portion 39a is a portion that is in contact with a portion of the back 32b at each of both the end portions of the first mirror plate 32 and presses each of both the end portions of the first mirror plate 32 against the positioning side 38g of the holding portion 38e of the holding hole 38d.

The elastic pushing portion 39b is a portion that is locked to the locking portion 38f of the holding hole 38d to mount the holder 39, is elastically deformed in a case where the portion is locked to the locking portion 38f, and elastically pushes the pressing portion 39a toward the positioning side 38g of the holding hole 38d.

The end portion-restricting portion 39c is a portion that inhibits and restricts the inadvertent movement of each of both the end portions of the first mirror plate 32 in the longitudinal direction Ld.

The elastic pushing portion 39b is bent and extends to be folded back from one end of the pressing portion 39a, and is formed to form a V shape together with the pressing portion 39a and to be elastically deformable. Further, an end portion 39be of the elastic pushing portion 39b is formed as a bent end portion that is bent to be in contact with and to be locked to a part of each of the mounting plates 38A and 38B near the upper side of the locking portion 38f of the holding hole 38d.

The end portion-restricting portion 39c is formed to be bent and extend from the other end of the pressing portion 39a to a side opposite to the elastic pushing portion 39b. Further, an end portion 39ce of the end portion-restricting portion 39c is formed as a bent end portion that is bent to be in contact with and to be locked to a part of each of the mounting plates 38A and 38B near the lower side of the holding portion 38e of the holding hole 38d.

The first mirror plate 32 is mounted on the mounting plates 38A and 38B as follows using the holders 39.

That is, first, after both the end portions of the first mirror plate 32 in the longitudinal direction Ld pass through the holding portions 38e of the holding holes 38d of the mounting plates 38A and 38B from the inside of the mounting plates 38A and 38B, respectively, as shown in FIG. 3A or 3B, the reflecting surface 32a is in contact with the positioning sides 38g.

Subsequently, after the elastic pushing portions 39b of the holders 39 are elastically deformed to be close to the pressing portions 39a, a part of the pressing portions 39a and the elastic pushing portions 39b in that state are caused to pass through the holding portions 38e and the locking portions 38f of the holding holes 38d of the mounting plates 38A and 38B from the outside of the mounting plates 38A and 38B, respectively.

Finally, a state where the elastic pushing portions 39b are elastically deformed is released at a stage where the end portions 39be of the elastic pushing portions 39b of the holders 39 reach the locking portions 38f of the holding holes 38d.

Accordingly, the elastic pushing portions 39b of the holders 39 are restored from elastic deformation and are in a locked state by butting against the upper sides of the locking portions 38f. On the other hand, the elastic pushing portions 39b elastically press the pressing portions 39a toward the back 32b at both the end portions of the first mirror plate 32 by a remaining restoring force against the elastic deformation.

As a result, both the end portions of the first mirror plate 32 are inserted into the holding holes 38d, and are elastically pressed by the pressing portions 39a of the holders 39, so that a state where the reflecting surface 32a is pressed against the positioning sides 38g of the holding holes 38d is maintained.

Both the end portions of the first mirror plate 32 in the longitudinal direction Ld are held and mounted in the holding holes 38d of the mounting plates 38A and 38B via the holders 39 as shown in FIG. 3A by the above-mentioned mounting work.

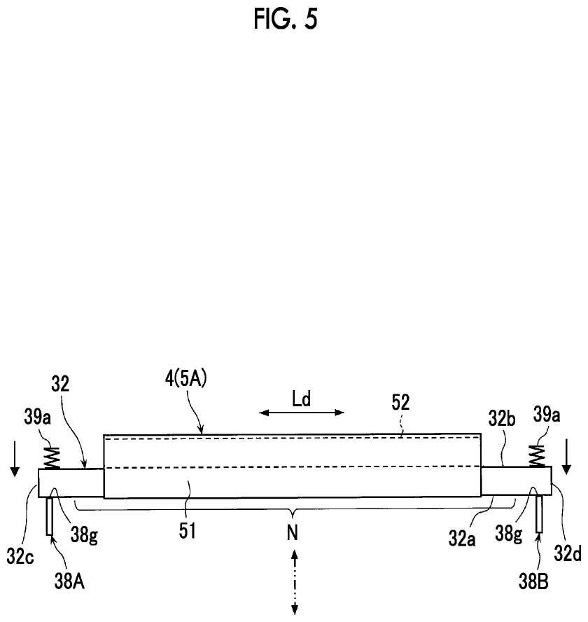

Further, the first mirror plate 32 at this time is held in a state where the reflecting surface 32a at both the end portions of the first mirror plate 32 in the longitudinal direction Ld is pressed against the positioning sides 38g of the holding holes 38d with required pressure (arrows shown in FIG. 5) by the pressing portions 39a of the holders 39 as shown in FIG. 5.

Vibration-Resistant Member Disposed on Mirror Plate

Furthermore, in the image reading apparatus 1, a vibration-resistant member 4, which imparts vibration resistance, is disposed on a part of some surfaces of at least the first mirror plate 32 of the plurality of mirror plates (32, 33, and 34) other than the reflecting surface 32a not to protrude from the reflecting surface 32a (see FIGS. 2, 4A, 4B, and 4C).

As shown in FIGS. 4A, 4B, and 4C, the surfaces of the first mirror plate 32 other than the reflecting surface 32a are the back 32b opposite to the reflecting surface 32a, a left side surface 32e and a right side surface 32f extending in the longitudinal direction Ld, and a front surface 32c and a rear surface 32d extending in the lateral direction Sd.

As shown in FIGS. 4A, 4B, and 4C, the vibration-resistant member 4 for the first mirror plate 32 of the first exemplary embodiment is formed of side reinforcing plates 5A and 5B that are fixed to and disposed on both the side surfaces 32e and 32f of the first mirror plate 32 extending in the longitudinal direction Ld.

That is, the first mirror plate 32 is a mirror plate having a required length L1, a required width W1, and a required thickness D as shown in FIGS. 4A, 4B, and 4C. For example, the width W1 is about 40 mm and the thickness D is about 5 mm.

Further, the lengths of the second mirror plate 33 and the third mirror plate 34 in the longitudinal direction are shorter than the length L1 of the first mirror plate 32, and the thicknesses of the second mirror plate 33 and the third mirror plate 34 are substantially equal to the thickness D of the first mirror plate 32.

As shown in FIG. 4B, the side reinforcing plates 5A and 5B are elongated plate-like members having a length L2 (<L1) and continuously present in an internal region avoiding portions, which are used to hold the first mirror plate 32 by the holders 39 or the like, from both the end portions 32c and 32d of the first mirror plate 32 in the longitudinal direction Ld.

In the first exemplary embodiment, a region excluding end portions, which extend inward from both the end portions 32c and 32d of the first mirror plate 32 by a required length Se, respectively, is set as the region avoiding the portions that are used to hold the first mirror plate 32 by the holders 39 or the like.

Further, as shown in FIG. 4C and the like, the side reinforcing plates 5A and 5B have a shape including standing portions 51 that stand up along both the side surfaces 32e and 32f without protruding from the reflecting surface 32a of the first mirror plate 32 and bent portions 52 that are bent inward at upper ends 51a of the standing portions 51. That is, each of the side reinforcing plates 5A and 5B is formed of a plate of which a cross-sectional shape is an L shape.

The standing portion 51 of the first exemplary embodiment is formed of a portion that stands from the position of the reflecting surface 32a on each of both the side surfaces 32e and 32f of the first mirror plate 32, which serves as a lower end 51b, by a dimension corresponding to the thickness D of the first mirror plate 32 and further stands to protrude upward from the back 32b of the first mirror plate 32.

For this reason, the standing portion 51 has a required height H1 exceeding the thickness D of the first mirror plate 32 and protrudes upward from the back 32b of the first mirror plate 32 by a protruding length E. The protruding length E is set to, for example, a dimension two or more times the thickness D of the first mirror plate 32.

The bent portion 52 of the first exemplary embodiment is formed of a portion that is bent from the upper end 51a of the standing portion 51 toward the inside facing the back 32b of the first mirror plate 32. The bent portion 52 is bent from the upper end 51a of the standing portion 51 to have a required bending length J, and the bending length J is set to, for example, a dimension equal to or smaller than ¼ of the width W1 of the first mirror plate 32. Further, the bent portion 52 is bent at a bending angle that is substantially a right angle to the standing portion 51, and the bending angle is not particularly limited as long as the stiffness (or strength) of the side reinforcing plates 5A and 5B can be ensured.

In addition, the thicknesses of the side reinforcing plates 5A and 5B are set from the viewpoint that, for example, the stiffness of the side reinforcing plates 5A and 5B is ensured, a deterioration in the flatness of the reflecting surface 32a caused by the deformation of the first mirror plate 32 due to the influence of the side reinforcing plates 5A and 5B does not occur, or the like.

The weights of the side reinforcing plates 5A and 5B are also set from the viewpoint identical to, for example, the case of the thicknesses.

Such side reinforcing plates 5A and 5B are made of a metal material, such as stainless steel, iron, or aluminum. Incidentally, the side reinforcing plates 5A and 5B may be made of other materials as long as the required stiffness of the side reinforcing plates 5A and 5B can be ensured. The above-mentioned required stiffness is, for example, a level of stiffness required to reinforce the first mirror plate 32.

Further, the side reinforcing plates 5A and 5B are fixed by being attached to both the side surfaces 32e and 32f of the first mirror plate 32 with adhesive means, such as a double-sided adhesive tape or an adhesive.

Furthermore, as shown in FIGS. 3A and 5, the first mirror plate 32 on which the side reinforcing plates 5A and 5B are disposed is held in the holding holes 38d of the mounting plates 38A and 38B by the holders 39.

At this time, the side reinforcing plates 5A and 5B of the first mirror plate 32 are not in contact with the holders 39.

### Operation of Image Reading Apparatus

In a case where the controller (not shown) of the image reading apparatus 1 receives an instruction for a reading operation, a transport operation for rotating the pairs of transport rollers 21, 22, and 23 in a direction in which the pairs of transport rollers 21, 22, and 23 of the transport unit 2 can transport the sheet 9 in the transport direction Td is started by a control operation of the controller.

Subsequently, in a case where the sheet 9 on which an image is formed by the image forming apparatus (not shown) or the like is fed to the image reading apparatus 1 through the carry-in port 10d of the housing 10, the sheet 9 is transported toward the reading unit 3 by the pair of transport rollers 21 and the transport guide members 25.

Then, in a case where the sheet 9 reaches the reading position of the reading unit 3 and starts to pass through the reading position, the image formed on one surface (upper surface) of the sheet 9 is read by the reading unit 3 in the image reading apparatus 1.

At this time, in the reading unit 3, the sheet 9 is irradiated with light from the illumination device 31 and reflected light from the sheet 9 passes through the first light shielding plate 37A and is then reflected by the first mirror plate 32, the second mirror plate 33, the third mirror plate 34, and the first mirror plate 32 in this order. After that, the reflected light reaches the imaging device 36 via the second light shielding plate 37B and the imaging lens 35. The reflected light is reflected twice by the first mirror plate 32. Finally, the reflected light having reached the imaging device 36 is converted into electrical signals.

The electrical signals obtained from the imaging device 36 are transmitted to the controller of the image reading apparatus 1 or an apparatus to be used in combination, such as the image forming apparatus (not shown), which is used while being connected to the image reading apparatus 1, and are generated as reading image data. The reading image data are used in, for example, image inspection processing.

Further, in the image reading apparatus 1, the sheet 9 having been read by the reading unit 3 is transported by the pairs of transport rollers 22 and 23 and the transport guide members 25 and is discharged from the discharge port 10e of the housing 10.

Incidentally, in a case where this reading operation is performed in the image reading apparatus 1, vibration is generated in the housing 10 due to an operation for transporting the sheet 9 or the like. This vibration is transmitted to the reading unit 3, so that a component, such as the first mirror plate 32, may be shaken.

In particular, during the reading operation, in a case where the front end 9a of the sheet 9 reaches the pair of transport rollers 22, which is present at first, after passing through the reading position of the reading unit 3, and is sandwiched between the pair of transport rollers 22, the sheet 9 collides with the pair of transport rollers 22 and impact vibration is generated. The vibration is likely to cause a component, such as the first mirror plate 32, to be shaken.

The shaking of the first mirror plate 32 occurs such that the first mirror plate 32 is slightly moved up and down at a portion N corresponding to a region inside portions where both the end portions 32c and 32d of the first mirror plate 32 in the longitudinal direction Ld are held as illustrated in FIG. 5 by a two-dot chain line with arrows.

In a case where a component, such as the first mirror plate 32, is vibrated as described above, the accuracy of the reading operation may be lowered. Further, in a case where a mirror plate, which reflects light twice as in the case of the first mirror plate 32, is vibrated, the accuracy of the reading operation is likely to be lowered.

In this regard, in the image reading apparatus 1, the side reinforcing plates 5A and 5B, which are the vibration-resistant member 4, are fixed to and disposed on both the side surfaces 32e and 32f of the first mirror plate 32 extending in the longitudinal direction Ld not to protrude from the reflecting surface 32a. Accordingly, the first mirror plate 32 is reinforced from both the side surfaces 32e and 32f, so that vibration resistance is imparted to the first mirror plate 32.

Therefore, even though the image reading apparatus 1 receives vibration caused by an operation, such as an operation for transporting the sheet 9, the shaking of the first mirror plate 32 is reduced or prevented without causing a deterioration in the flatness of the reflecting surface 32a and the generation of stray light as compared to a case where the side reinforcing plates 5A and 5B are not disposed on the first mirror plate 32.

Here, the vibration resistance is a property that allows an object to be maintained in a state where the object resists vibration to be less likely to be shaken in a case where vibration causing the occurrence of shaking is applied from the outside.

A deterioration in the flatness of the reflecting surface 32a means that flatness deteriorates due to the influence of the side reinforcing plates 5A and 5B which are fixed and disposed.

The generation of the stray light is a phenomenon in which a part of reflected light generated during reading is applied to protruding portions of the side reinforcing plates 5A and 5B and reflected light having a direction different from the direction of the reflected light from the reflecting surface 32a is generated in a case where the side reinforcing plates 5A and 5B protrude from the reflecting surface 32a.

Further, in the image reading apparatus 1, the side reinforcing plates 5A and 5B are fixed to and disposed on both the side surfaces 32e and 32f of the first mirror plate 32 extending in the longitudinal direction Ld. Accordingly, the first mirror plate 32 is reinforced from both the side surfaces 32e and 32f in the image reading apparatus 1 as compared to a case where only one of the side reinforcing plates 5A and 5B is fixed to and disposed on one of the side surfaces 32e and 32f of the first mirror plate 32. Therefore, the shaking of the first mirror plate 32 is further reduced and a deterioration in the flatness of the reflecting surface 32a is also not caused.

Further, in the image reading apparatus 1, the side reinforcing plates 5A and 5B are fixed and disposed to protrude from the back 32b of the first mirror plate 32. For this reason, the first mirror plate 32 is further reinforced from both the side surfaces 32e and 32f as compared to a case where the side reinforcing plates 5A and 5B do not protrude from the back 32b of the first mirror plate 32. Accordingly, even though the image reading apparatus 1 receives vibration caused by an operation, such as an operation for transporting the sheet 9, the shaking of the first mirror plate 32 is further reduced.

Moreover, the side reinforcing plates 5A and 5B including the bent portions 52 are applied in the image reading apparatus 1. For this reason, reinforcement using the side reinforcing plates 5A and 5B is enhanced as compared to a case where the side reinforcing plates 5A and 5B do not include the bent portions 52. Accordingly, even though the image reading apparatus 1 receives vibration caused by an operation, such as an operation for transporting the sheet 9, the shaking of the first mirror plate 32 is further reduced.

### Modification Example of Side Reinforcing Plate

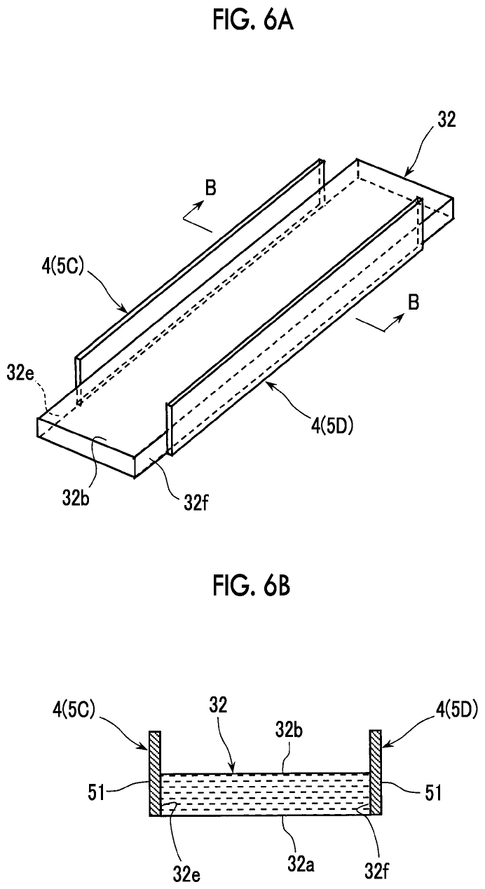

Instead of the side reinforcing plates 5A and 5B, side reinforcing plates illustrated in FIGS. 6A to 10B may be applied as the vibration-resistant member 4 that is disposed on both the side surfaces 32e and 32f of the first mirror plate 32.

Side reinforcing plates 5C and 5D of Modification Example 1 shown in FIGS. 6A and 6B are reinforcing plates that are formed of only the standing portions 51 of the side reinforcing plates 5A and 5B (see FIGS. 4A, 4B, and 4C) excluding the bent portions 52.

In a case where the side reinforcing plates 5C and 5D are applied, the first mirror plate 32 is reinforced by the side reinforcing plates 5C and 5D having a simpler structure, so that vibration resistance can be imparted to the first mirror plate 32.

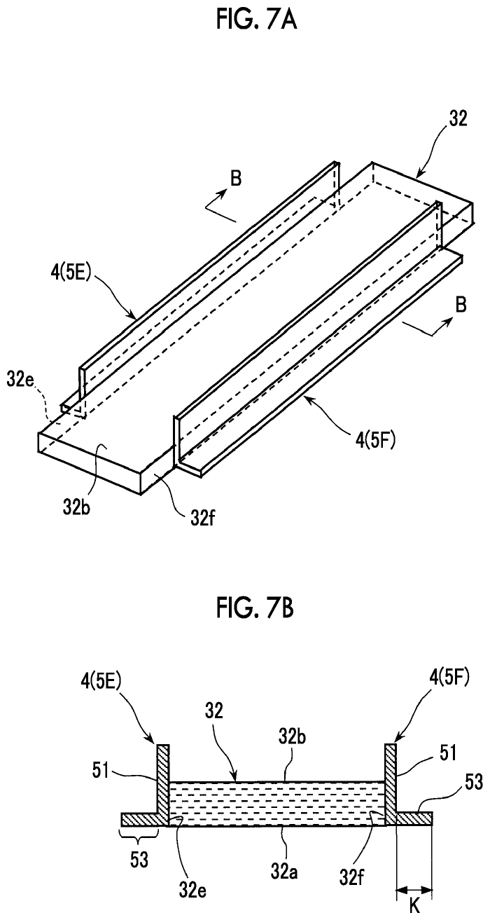

Side reinforcing plates 5E and 5F of Modification Example 2 shown in FIGS. 7A and 7B are reinforcing plates that include bent portions 53 at lower ends 51b of the standing portions 51 of the side reinforcing plates 5C and 5D of the Modification Example 1.

The bent portions 53 are formed of portions that are bent at the lower ends 51b of the standing portions 51 in a direction in which the portions are away from both the side surfaces 32e and 32f of the first mirror plate 32 (outward), respectively. The bent portion 53 is bent from a lower end portion of the standing portion 51 to have a required bending length K, and the bending length K is a dimension equal to or shorter than the bending length J of the bent portion 52. Further, the bent portion 53 is bent at a bending angle that is substantially a right angle to the standing portion 51, and the bending angle is not limited thereto.

In a case where the side reinforcing plates 5E and 5F are applied, the stiffness of the side reinforcing plates 5E and 5F is increased as compared to the side reinforcing plates 5C and 5D of Modification Example 1 not including the bent portions 53. Accordingly, the first mirror plate 32 is further reinforced, so that higher vibration resistance can be imparted to the first mirror plate 32.

The bent portions 53 are not limited to a case where the bent portions 53 are formed at the lower ends 51b of the standing portions 51, and may be formed at positions excluding the lower ends 51b in a range of portions of the standing portions 51 that are in contact with both the side surfaces 32e and 32f of the first mirror plate 32.

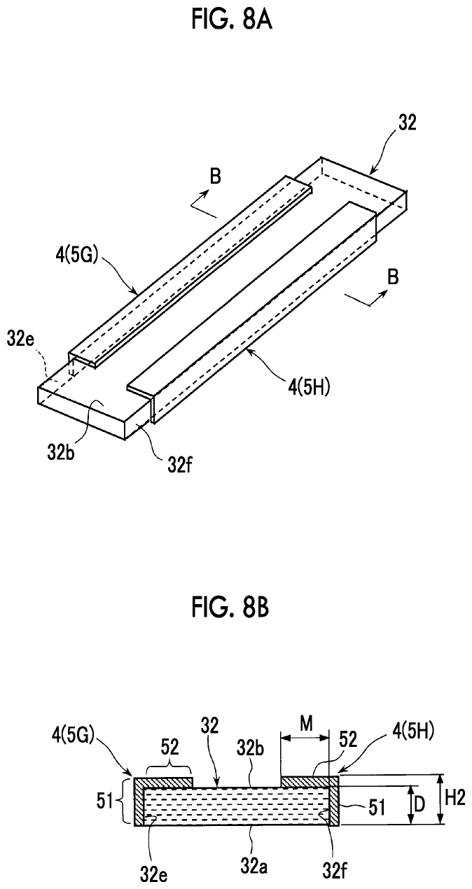

Side reinforcing plates 5G and 5H of Modification Example 3 shown in FIGS. 8A and 8B are reinforcing plates of which the heights H1 of the standing portions 51 of the side reinforcing plates 5A and 5B (FIGS. 4A, 4B, and 4C) are set to low heights H2 (<H1) and the bent portions 52 are in contact with or are attached and fixed to the back 32b of the first mirror plate 32.

The bent portions 52 are identical to the bent portion 52 (see FIGS. 4A, 4B, and 4C) of the side reinforcing plates 5A and 5B.

In a case where the side reinforcing plates 5G and 5H are applied, the first mirror plate 32 is further reinforced as compared to a case where the side reinforcing plates of which the bent portions 52 are not in contact with or are not fixed to the back 32b of the first mirror plate 32 are used. Accordingly, the first mirror plate 32 is further reinforced, so that higher vibration resistance can be imparted to the first mirror plate 32.

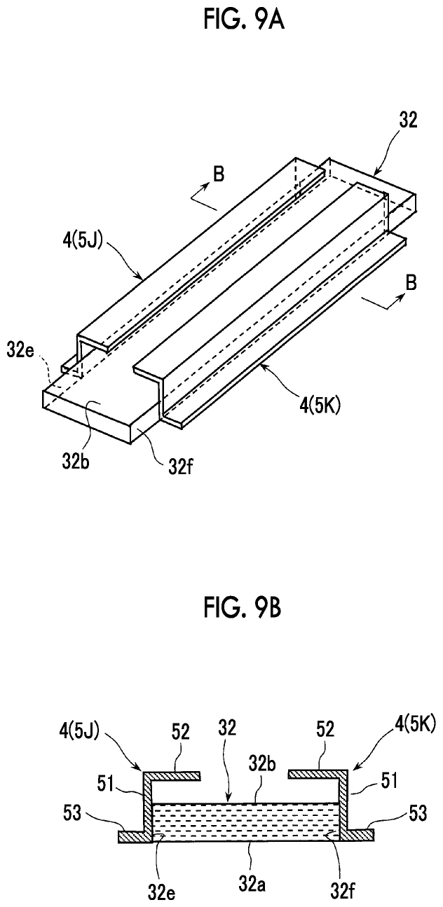

Side reinforcing plates 5J and 5K of Modification Example 4 shown in FIGS. 9A and 9B are reinforcing plates having a shape in which bent portions 53 are added to the lower ends 51b of the standing portions 51 of the side reinforcing plates 5A and 5B (FIGS. 4A, 4B, and 4C).

The bent portion 53 is identical to the bent portion 53 (see FIGS. 7A and 7B) of Modification Example 2.

In a case where the side reinforcing plates 5J and 5K are applied, the stiffness of the side reinforcing plates 5J and 5K is further increased as compared to the side reinforcing plates not including the bent portions 52 and 53. Accordingly, the first mirror plate 32 is further reinforced, so that higher vibration resistance can be imparted to the first mirror plate 32.

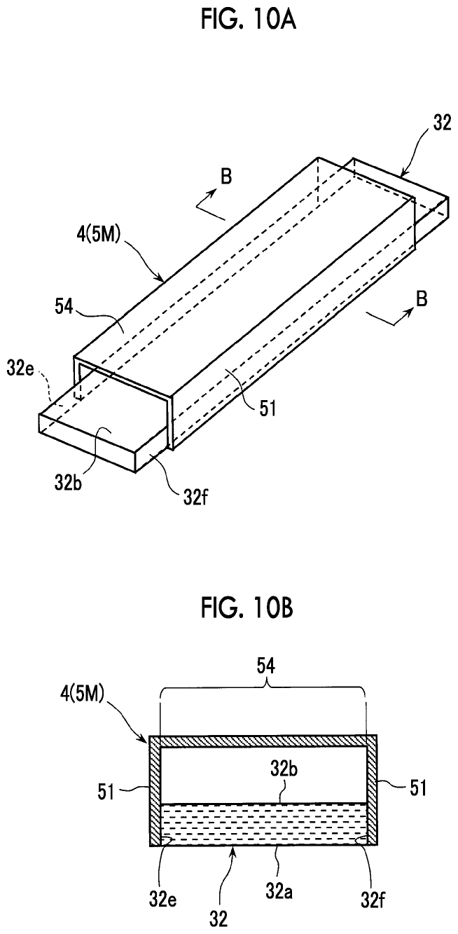

A side reinforcing plate 5M of Modification Example 5 shown in FIGS. 10A and 10B is a reinforcing plate that has a shape including a connecting portion 54 connecting the upper ends 51a of the standing portions 51 of the side reinforcing plates 5A and 5B (FIGS. 4A, 4B, and 4C).

The connecting portion 54 is a portion that is obtained simultaneously with the standing portions 51 in a case where, for example, a substrate of the reinforcing plate is bent or formed. The connecting portion 54 is away from the back 32b of the first mirror plate 32. Accordingly, there is a merit that a deviation in component tolerance generated during the machining of the first mirror plate 32 is absorbed in a space between the connecting portion 54 and the back 32b that are away from each other. The connecting portion 54 may be adapted to be in contact with or to be fixed to the back 32b of the first mirror plate 32.

In a case where the side reinforcing plate 5M is applied, the stiffness of the side reinforcing plate 5M is increased as compared to a side reinforcing plate that does not include the connecting portion 54 connecting the standing portions 51. Accordingly, the first mirror plate 32 is further reinforced, so that higher vibration resistance can be imparted to the first mirror plate 32.

### Second Exemplary Embodiment

An image reading apparatus 1 according to a second exemplary embodiment of the present invention is different from the image reading apparatus 1 according to the first exemplary embodiment in that a plurality of back reinforcing plates are arranged on the first mirror plate 32 of the reading unit 3 as a vibration-resistant member 4, but the other configuration of the image reading apparatus 1 according to the second exemplary embodiment is identical to the configuration of the image reading apparatus 1 according to the first exemplary embodiment.

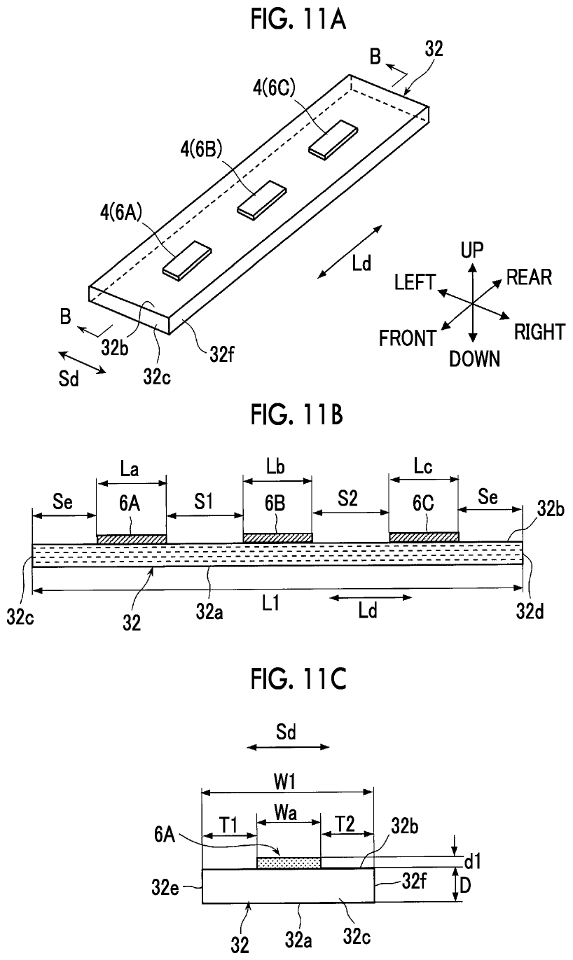

As shown in FIGS. 11A, 11B, and 11C, the vibration-resistant member 4 of the second exemplary embodiment is formed of a plurality of back reinforcing plates 6A, 6B, and 6C that are fixed to and arranged on the back 32b of the first mirror plate 32 at a plurality of positions (three positions in the present exemplary embodiment) arranged at intervals S in the longitudinal direction Ld.

The back reinforcing plates 6A, 6B, and 6C are rectangular plates that have lengths La, Lb, and Lc in the longitudinal direction Ld, a width Wa in the lateral direction Sd, and a thickness dl. The lengths La, Lb, and Lc have an identical dimension.

The back reinforcing plates 6A, 6B, and 6C may be plates having vibration properties (natural frequencies or the like) different from the natural frequency of the first mirror plate 32, and are plates made of a material, such as rubber, a synthetic resin, such as a urethane resin, or metal.

Further, the back reinforcing plates 6A, 6B, and 6C are arranged at intervals S1 and S2 in an internal region away from both end portions of the back 32b of the first mirror plate 32 in the longitudinal direction Ld by distances Se. Since the intervals S1 and S2 are set to an identical dimension in the second exemplary embodiment, the back reinforcing plates 6A, 6B, and 6C are arranged at regular intervals in a region that avoids holding positions on both the end portions of the back 32b of the first mirror plate 32 in the longitudinal direction Ld and excludes portions corresponding to the distances Se.

Furthermore, the back reinforcing plates 6A, 6B, and 6C are arranged on the back 32b of the first mirror plate 32 at positions away from both the side surfaces 32e and 32f, which extend in the longitudinal direction Ld, in the lateral direction Sd by distances T1 and T2. Since the distances T1 and T2 are set to an identical dimension in the second exemplary embodiment, all of the back reinforcing plates 6A, 6B, and 6C are arranged on the back 32b of the first mirror plate 32 at a middle position in the lateral direction Sd.

The back reinforcing plates 6A, 6B, and 6C are fixed at required positions on the back 32b of the first mirror plate 32 by being attached with adhesive means, such as a double-sided adhesive tape or an adhesive. In this case, it goes without saying that the back reinforcing plates 6A, 6B, and 6C do not protrude from the reflecting surface 32a of the first mirror plate 32.

Further, the first mirror plate 32 on which the back reinforcing plates 6A, 6B, and 6C are arranged is reinforced from the back 32b, so that vibration resistance is imparted to the first mirror plate 32.

Accordingly, even though the image reading apparatus 1 including the reading unit 3 to which the first mirror plate 32 on which the back reinforcing plates 6A, 6B, and 6C are arranged is applied receives vibration caused by an operation, such as an operation for transporting the sheet 9, the shaking of the first mirror plate 32 is reduced by simple configuration without causing not only the generation of stray light but also, more particularly, a deterioration in the flatness of the reflecting surface 32a as compared to a case where the vibration-resistant member 4 is formed of one back reinforcing plate continuously fixed to the back 32b of the first mirror plate 32 in the longitudinal direction Ld.

### Modification Example Related to Back Reinforcing Plate

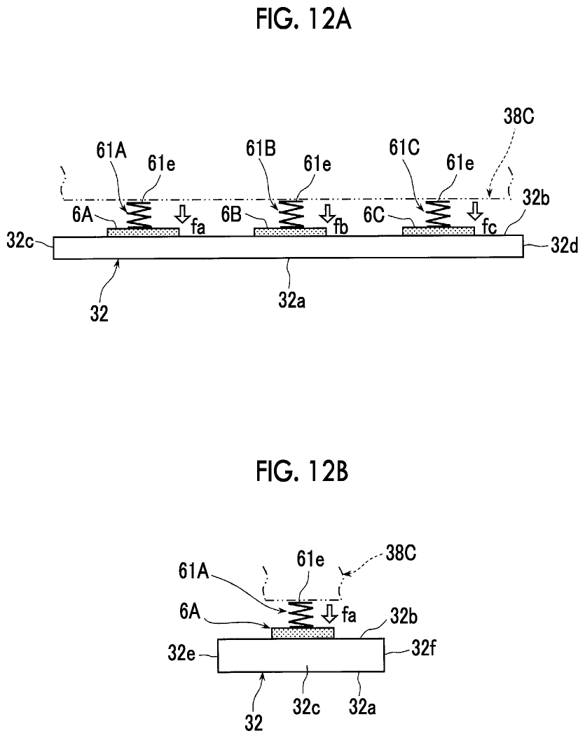

In a case where the back reinforcing plates 6A, 6B, and 6C are arranged on the first mirror plate 32 of the reading unit 3, first pressing members 61A, 61B, and 61C that continue to elastically press the backs of the back reinforcing plates 6A, 6B, and 6C opposite to the first mirror plate 32 may be provided as shown in FIGS. 12A and 12B.

The first pressing members 61A, 61B, and 61C may be any members as long as the members can suppress the occurrence of the shaking of the first mirror plate 32 by pressing the first mirror plate 32 with an elastic pressing load in a case where the first mirror plate 32 is likely to be shaken, and members, such as a coil spring and a leaf spring, are applied as the first pressing members 61A, 61B, and 61C.

Further, the first pressing members 61A, 61B, and 61C are arranged such that one ends 61e of the first pressing members 61A, 61B, and 61C are fixed to mounting portions 38C provided at required portions of the housing 30 and the other ends of the first pressing members 61A, 61B, and 61C continue to be in contact with the backs of the back reinforcing plates 6A, 6B, and 6C at substantially central positions of the back reinforcing plates 6A, 6B, and 6C as free ends.

Further, as illustrated in FIG. 12A by white arrows, the first pressing members 61A, 61B, and 61C continue to elastically push the back reinforcing plates 6A, 6B, and 6C toward the first mirror plate 32 with required pressing loads (elastic pressing forces) fa, fb, and fc.

The pressing loads fa, fb, and fc at this time are set to an identical pressing load. At least one of the pressing load fa, fb, or fc may be set to a different pressing load depending on, for example, information, such as a difference in the degree of shaking of the first mirror plate 32.

Further, the first mirror plate 32 on which the first pressing members 61A, 61B, and 61C are additionally arranged is further reinforced from the back 32b due to not only the presence of the back reinforcing plates 6A, 6B, and 6C but also the pressing of the first pressing members 61A, 61B, and 61C, so that higher vibration resistance is imparted to the first mirror plate 32.

Accordingly, even though the image reading apparatus 1 including the reading unit 3 to which the first mirror plate 32 on which the back reinforcing plates 6A, 6B, and 6C to which the first pressing members 61A, 61B, and 61C are added are arranged is applied receives vibration caused by an operation, such as an operation for transporting the sheet 9, the shaking of the first mirror plate 32 is suppressed and reduced without causing a deterioration in the flatness of the reflecting surface 32a and the generation of stray light as compared to a case where the back reinforcing plates 6A, 6B, and 6C are not provided with the first pressing members 61A, 61B, and 61C.

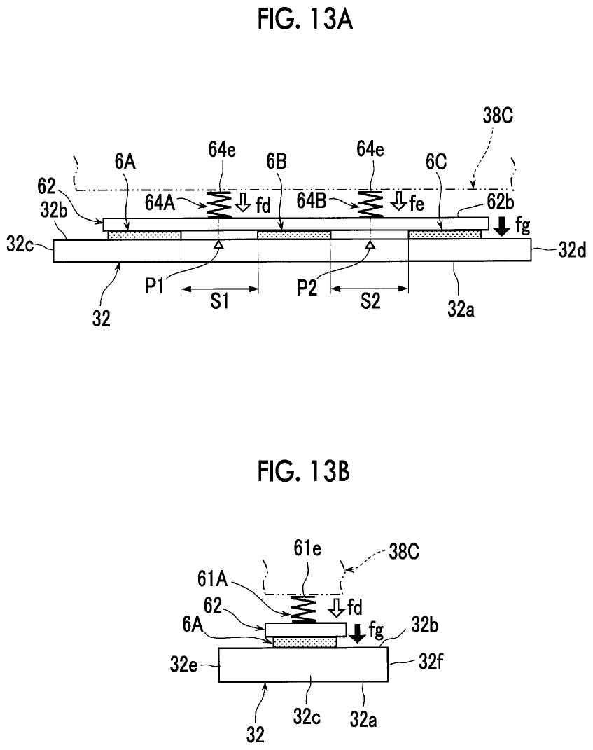

Further, in a case where the back reinforcing plates 6A, 6B, and 6C are arranged on the first mirror plate 32 of the reading unit 3, a plate 62 that is in continuous contact with the backs of the back reinforcing plates 6A, 6B, and 6C and second pressing members 64A and 64B that continue to elastically press a back 62b of the plate 62 opposite to a side of the plate 62, which is in contact with the back reinforcing plates 6A, 6B, and 6C, are may be provided as shown in FIGS. 13A and 13B.

A single plate that has a size and shape allowing the plate to be simultaneously in contact with the entire surface of the respective backs of the back reinforcing plates 6A, 6B, and 6C is applied as the plate 62. It is preferable that, for example, the plate 62 has high stiffness not to be easily bent, and the plate 62 is made of a material from which a hard molded plate is obtained, such as a synthetic resin, metal, or a composite material, to have a plate shape.

Since the plate 62 is pressed by the second pressing members 64A and 64B, the plate 62 may simply be placed in contact with the respective backs of the back reinforcing plates 6A, 6B, and 6C. However, the plate 62 may be disposed to lightly adhere to the respective backs of the back reinforcing plates 6A, 6B, and 6C.

As with the first pressing members 61A, 61B, and 61C, members, such as a coil spring and a leaf spring, are applied as the second pressing members 64A and 64B.

Further, the second pressing members 64A and 64B are arranged such that one ends 64e of the second pressing members 64A and 64B are fixed to mounting portions 38C provided at required portions of the housing 30 and the other ends of the second pressing members 64A and 64B continue to be in contact with required portions of the back of the plate 62 as free ends.

In this case, it is preferable that, for example, the second pressing members 64A and 64B are arranged in contact with the plate 62 at intermediate positions (middle positions) between the back reinforcing plates 6A, 6B, and 6C as shown in FIG. 13A.

Further, in the case of the first mirror plate 32, the second pressing members 64A and 64B continue to press the plate 62 with required pressing loads fd and fe as illustrated in FIG. 13A by thick white arrows, so that the plate 62 continues to elastically push the back reinforcing plates 6A, 6B, and 6C toward the first mirror plate 32 with a common pressing load fg.

The pressing loads (elastic forces) fd and fe of the second pressing members 64A and 64B at this time are set to an identical pressing load.

Furthermore, the first mirror plate 32 on which the second pressing members 64A and 64B and the plate 62 are additionally arranged on the back reinforcing plates 6A, 6B, and 6C is further reinforced from the back 32b due to not only the presence of the back reinforcing plates 6A, 6B, and 6C but also the pressing of the second pressing members 64A and 64B, so that higher vibration resistance is imparted to the first mirror plate 32. In particular, since the pressing loads fd and fe of the second pressing members 64A and 64B are applied to the back reinforcing plates 6A, 6B, and 6C via the plate 62 as the common pressing load fg, vibration resistance is imparted to the first mirror plate 32 in a state where the first mirror plate 32 is substantially equally pressed and is evenly reinforced.

Accordingly, even though the image reading apparatus 1 including the reading unit 3 to which the first mirror plate 32 on which the back reinforcing plates 6A, 6B, and 6C to which the plate 62 and the second pressing members 64A and 64B are added are arranged is applied receives vibration caused by an operation, such as an operation for transporting the sheet 9, the shaking of the first mirror plate 32 is further suppressed and reduced without causing a deterioration in the flatness of the reflecting surface 32a and the generation of stray light as compared to a case where the back reinforcing plates 6A, 6B, and 6C are not provided with the plate 62 and the second pressing members 64A and 64B.

Further, in the image reading apparatus 1, as shown in FIG. 13A, the second pressing members 64A and 64B provided on the first mirror plate 32 are arranged to continue to press portions of the plate 62 corresponding to the intermediate positions P1 and P2 between the back reinforcing plates 6A, 6B, and 6C. For this reason, the pressing loads fd and fe of the second pressing members 64A and 64B are equally applied to the back reinforcing plates 6A, 6B, and 6C via the plate 62 as a common pressing load fg.

As a result, even though the image reading apparatus 1 receives vibration caused by an operation, such as an operation for transporting the sheet 9, the shaking of the first mirror plate 32 is evenly reduced as compared to a case where the second pressing members 64A and 64B are arranged to continue to press portions of the plate 62 other than the intermediate positions P1 and P2.

### Third Exemplary Embodiment

An image reading apparatus 1 according to a third exemplary embodiment of the present invention is different from the image reading apparatus 1 according to the first exemplary embodiment in that a plurality of back pressing members are arranged on the first mirror plate 32 of the reading unit 3 as a vibration-resistant member 4, but the other configuration of the image reading apparatus 1 according to the third exemplary embodiment is identical to the configuration of the image reading apparatus 1 according to the first exemplary embodiment.

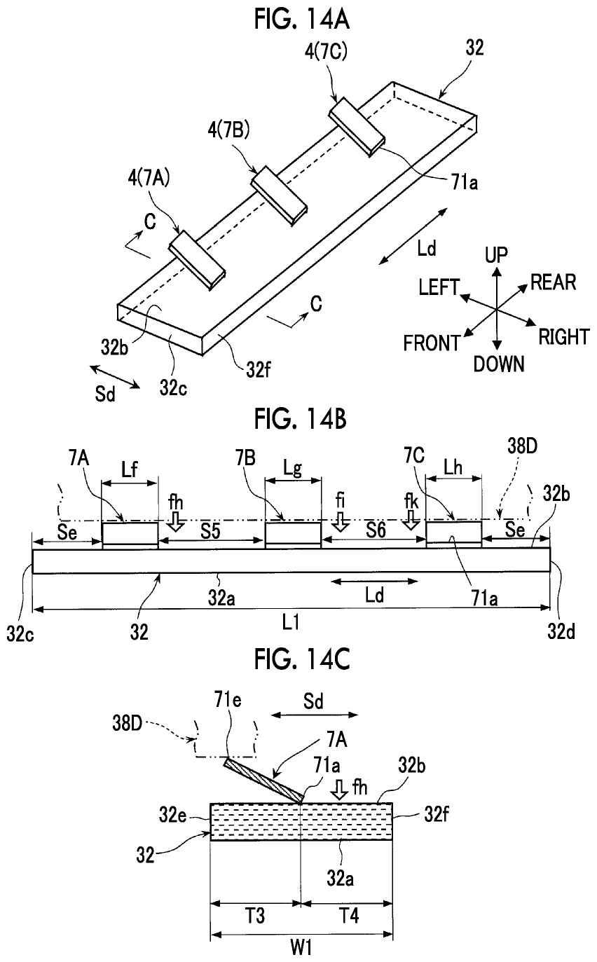

As shown in FIG. 14B, the vibration-resistant member 4 of the third exemplary embodiment is formed of back pressing members 7A, 7B, and 7C that are in elastic contact with and press the back 32b of the first mirror plate 32 at a plurality of positions (three positions in the present exemplary embodiment) arranged at intervals S in the longitudinal direction Ld.

The back pressing members 7A, 7B, and 7C are rectangular plates that have lengths (widths) Lf, Lg, and Lh in the longitudinal direction Ld, required lengths in the lateral direction Sd, and required thicknesses. All of the lengths Lf, Lg, and Lh of the back pressing members 7A, 7B, and 7C have an identical dimension, all of the lengths in the lateral direction Sd have an identical dimension, and all of the thicknesses have an identical dimension.

The back pressing members 7A, 7B, and 7C may be any members as long as the members can suppress the occurrence of the shaking of the first mirror plate 32 by pressing the first mirror plate 32 with an elastic pressing load in a case where the first mirror plate 32 is likely to be shaken, and members, such as sheet metal formed of, for example, a leaf spring, are applied as the back pressing members 7A, 7B, and 7C.

Further, the back pressing members 7A, 7B, and 7C are arranged such that one ends 71e of the back pressing members 7A, 7B, and 7C are fixed to mounting portions 38D provided at required portions of the housing 30 and the other ends of the back pressing members 7A, 7B, and 7C continue to be in contact with required portions of the back 32b of the first mirror plate 32 as free ends as shown in FIG. 14C and the like.

Furthermore, the back pressing members 7A, 7B, and 7C are arranged at intervals S5 and S6 in an internal region away from both end portions of the back 32b of the first mirror plate 32 in the longitudinal direction Ld by distances Se. Since the intervals S5 and S6 are set to an identical dimension in the third exemplary embodiment, the back pressing members 7A, 7B, and 7C are arranged at regular intervals in a region that avoids holding positions on both the end portions of the back 32b of the first mirror plate 32 in the longitudinal direction Ld and excludes portions corresponding to the distances Se.

Moreover, the back pressing members 7A, 7B, and 7C are arranged on the back 32b of the first mirror plate 32 at positions away from both the side surfaces 32e and 32f in the lateral direction Sd by distances T3 and T4. Since the distances T3 and T4 are set to an identical dimension in the third exemplary embodiment, all of the back pressing members 7A, 7B, and 7C are arranged to be in contact with the back 32b of the first mirror plate 32 at a middle position in the lateral direction Sd.

Further, as illustrated in FIG. 14B by thick white arrows, the back pressing members 7A, 7B, and 7C continue to elastically push the back 32b of the first mirror plate 32 with required pressing loads fh, fi, and fk.

The pressing loads fh, fi, and fk at this time are set to an identical pressing load. At least one of the pressing load fh, fi, or fk may be set to an elastic force depending on, for example, information, such as a difference in the degree of shaking of the first mirror plate 32.

Further, since the first mirror plate 32 on which the back pressing members 7A, 7B, and 7C are arranged is pressed from the back 32b by the elastic pressing of the back pressing members 7A, 7B, and 7C, the shaking of the first mirror plate 32 is suppressed in a case where the first mirror plate 32 is likely to be shaken. As a result, vibration resistance is further imparted to the first mirror plate 32.

Accordingly, even though the image reading apparatus 1 including the reading unit 3 to which the first mirror plate 32 on which the back pressing members 7A, 7B, and 7C are arranged is applied receives vibration caused by an operation, such as an operation for transporting the sheet 9, the shaking of the first mirror plate 32 is suppressed and reduced as compared to a case where the vibration-resistant member 4 is formed of one back pressing member that is disposed to continue to elastically press the back 32b of the first mirror plate 32 at one position in the longitudinal direction Ld.

Further, in a case where at least one of the pressing load fh, fi, or fk of the back pressing member 7A, 7B, or 7C is set to be different from the other pressing loads, the shaking of the first mirror plate 32 is appropriately reduced as compared to a case where all of the pressing loads fh, fi, and fk of the back pressing members 7A, 7B, and 7C are identical to each other even though the image reading apparatus 1 receives vibration caused by an operation, such as an operation for transporting the sheet 9.

### Modification Examples

The exemplary embodiments of the present invention have been described above, but the present invention is not limited to the configurations exemplified as the first to third exemplary embodiments and may include various modifications and embodiments without departing from the scope of the present invention described in claims and the like. For this reason, the present invention also includes, for example, Modification Examples exemplified below.

A case where three back reinforcing plates 6A, 6B, and 6C are arranged has been exemplified in the second exemplary embodiment, but two back reinforcing plates may be arranged or four or more back reinforcing plates may be arranged.

With regard to the first pressing members 61A, 61B, and 61C, first pressing members of which the number corresponds to the number of back reinforcing plates may be provided.

Even with regard to the second pressing members 64A and 64B, second pressing members of which the number corresponds to the number of back reinforcing plates may be provided. Further, in a case where the plate 62 is provided and two back reinforcing plates 6 are provided, the number of second pressing members 64 can be one (single).

A case where three back pressing members 7A, 7B, and 7C are arranged has been exemplified in the third exemplary embodiment, but two back pressing members may be arranged or four or more back pressing members may be arranged.

A case where the vibration-resistant member 4 is disposed on the first mirror plate 32 has been exemplified in the first to third exemplary embodiments, but the vibration-resistant member 4 may be disposed on the second mirror plate 33 or the third mirror plate 34 other than the first mirror plate 32. The first mirror plate 32 may be a mirror plate that reflects light once.

The transport unit 2 may be configured in combination with a transport device of another type (for example, a suction type belt transport device).

A case where the reading unit 3 includes three mirror plates (32, 33, and 34) has been exemplified, but the reading unit 3 may be a reading unit including one mirror plate or may be a reading unit including a plurality of other mirror plates.

The image reading apparatus 1 may be provided with not only a first reading unit that reads an image formed on one surface (upper surface) of a sheet 9 to be transported but also a second reading unit that reads an image formed on the other surface (lower surface) of the sheet 9 to be transported, as the reading unit 3.

### Supplementary Note

(((1)))

An image reading apparatus comprising:
a transport unit that transports a sheet including an image; and
a reading unit that includes a mirror plate of which both end portions in a longitudinal direction are held, reflects reflected light, which is obtained by illuminating the sheet transported by the transport unit with light, by a reflecting surface of the mirror plate, and reads the image,
wherein a vibration-resistant member, which imparts vibration resistance, is disposed on a part of some surfaces of the mirror plate other than the reflecting surface not to protrude from the reflecting surface.

(((2)))

The image reading apparatus according to (((1))),
wherein the vibration-resistant member is formed of side reinforcing plates that are fixed to and disposed on both side surfaces of the mirror plate extending in the longitudinal direction.

(((3)))

The image reading apparatus according to (((1))),
wherein the vibration-resistant member is formed of a plurality of back reinforcing plates that are fixed to and arranged on a back of the mirror plate opposite to the reflecting surface at a plurality of positions arranged at intervals in the longitudinal direction.

(((4)))

The image reading apparatus according to (((1))),
wherein the vibration-resistant member is formed of a plurality of back pressing members that are arranged to continue to elastically press a back of the mirror plate opposite to the reflecting surface at a plurality of positions arranged at intervals in the longitudinal direction.

(((5)))

The image reading apparatus according to (((2))),
wherein the side reinforcing plates protrude from a back of the mirror plate opposite to the reflecting surface.

(((6)))

The image reading apparatus according to (((2))) or (((5))),
wherein each of the side reinforcing plates includes a bent portion formed at a portion of the side reinforcing plate protruding from the back.

(((7)))

The image reading apparatus according to (((3))), further comprising:
a plurality of first pressing members that continue to elastically press backs of the plurality of back reinforcing plates opposite to the mirror plate, respectively.

(((8)))

The image reading apparatus according to (((3))), further comprising:
a plate that is in continuous contact with backs of the plurality of back reinforcing plates opposite to the mirror plate; and
a single second pressing member or a plurality of second pressing members that continue to elastically press a back of the plate opposite to a side of the plate, which is in contact with the back reinforcing plates.

(((9)))

The image reading apparatus according to (((8))),
wherein the second pressing members are arranged to continue to press portions of the back of the plate corresponding to intermediate positions between the plurality of back reinforcing plates.

(((10)))

The image reading apparatus according to (((4))),
wherein at least a part of pressing loads of the plurality of back pressing members are set to be different from the other pressing loads.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
a transport unit that transports a sheet including an image; and
a reading unit that includes a mirror plate of which both end portions in a longitudinal direction are held, reflects reflected light, which is obtained by illuminating the sheet transported by the transport unit with light, by a reflecting surface of the mirror plate, and reads the image,
wherein a vibration-resistant member, which imparts vibration resistance, is disposed on a part of some surfaces of the mirror plate other than the reflecting surface not to protrude from the reflecting surface.

2. The image reading apparatus according to claim 1,
wherein the vibration-resistant member is formed of side reinforcing plates that are fixed to and disposed on both side surfaces of the mirror plate extending in the longitudinal direction.

3. The image reading apparatus according to claim 1,
wherein the vibration-resistant member is formed of a plurality of back reinforcing plates that are fixed to and arranged on a back of the mirror plate opposite to the reflecting surface at a plurality of positions arranged at intervals in the longitudinal direction.

4. The image reading apparatus according to claim 1,
wherein the vibration-resistant member is formed of a plurality of back pressing members that are arranged to continue to elastically press a back of the mirror plate opposite to the reflecting surface at a plurality of positions arranged at intervals in the longitudinal direction.

5. The image reading apparatus according to claim 2,
wherein the side reinforcing plates protrude from a back of the mirror plate opposite to the reflecting surface.

6. The image reading apparatus according to claim 5,
wherein each of the side reinforcing plates includes a bent portion formed at a portion of the side reinforcing plate protruding from the back.

7. The image reading apparatus according to claim 3, further comprising:
a plurality of first pressing members that continue to elastically press backs of the plurality of back reinforcing plates opposite to the mirror plate, respectively.

8. The image reading apparatus according to claim 3, further comprising:
a plate that is in continuous contact with backs of the plurality of back reinforcing plates opposite to the mirror plate; and
a single second pressing member or a plurality of second pressing members that continue to elastically press a back of the plate opposite to a side of the plate, which is in contact with the back reinforcing plates.

9. The image reading apparatus according to claim 8,
wherein the second pressing members are arranged to continue to press portions of the back of the plate corresponding to intermediate positions between the plurality of back reinforcing plates.

10. The image reading apparatus according to claim 4,
wherein at least a part of pressing loads of the plurality of back pressing members are set to be different from the other pressing loads.
